(19) United States
(12) Patent Application Publication
(10) Pub. No.: US 2016/0161726 A1
(43) Pub. Date: Jun. 9, 2016

(54) MULTI-SPIRAL OPTICAL DEVICE

(71) Applicant: METAL INDUSTRIES RESEARCH & DEVELOPMENT CENTRE, Kaohsiung City (TW)

(72) Inventors: CHENG-HUAN CHEN, TAOYUAN CITY (TW); SHENG-RONG LIN, NEW TAIPEI CITY (TW); YUAN-JIE ZHENG, KAOHSIUNG CITY (TW)

(21) Appl. No.: 14/956,514

(22) Filed: Dec. 2, 2015

(30) Foreign Application Priority Data
Dec. 3, 2014 (TW) 103142062

(51) Int. Cl. G02B 19/00; G02B 3/12; F21S 11/00; G02B 3/08

(52) U.S. Cl. CPC G02B 19/0009; G02B 3/08; G02B 19/0042; G02B 3/12; F21S 11/002

(57) ABSTRACT

The present invention provides a multi-spiral optical device, which comprises a base and a plurality of spiral channels. The plurality of spiral channels are formed on the base and include a first port and a second port, respectively. The plurality of first ports are located at the center of the base; the plurality of second ports are located at the periphery of the base. Thereby, the multi-spiral optical device can form a light concentrating device. In addition, a fluid can be filled to or drawn from one or more of the plurality of spiral channels for switching the optical state of the multi-spiral optical device. By filling or drawing the fluid to or from the plurality of spiral channels selectively, they can be switched to a light-pervious, a sheltering, or a light-concentrating state according to users' requirements.

### FIELD OF THE INVENTION

The present invention relates generally to an optical device, and particularly to a multi-spiral optical device.

### BACKGROUND OF THE INVENTION

In this era having rapidly growing population, the demand for a variety of energy and resources grows correspondingly. Unfortunately, the available resources from the earth are limited. Scientists have to figure out other ways to acquire more energy, including producing energy or reusing it. According to statistics, energy consumption of buildings occupies over 30% of the global energy consumption. This is closely related to the population increase and technological advancements. People rely more on electricity; most devices adopted in daily lives demand electricity. Consequently, how to create and make good use of energy has become a major issue worldwide. Among various research and development projects for green energy invested by governments, research institutes, and the industry, the promotion for green buildings has gradually become the regulation for next-generation architectural designs.

The environmentally protective concept of saving energy using green buildings has been valued gradually in new building designs. In particular, the exposed walls acting the interface function between the interior and the exterior environment play a key role in building material for the efficacy of saving energy. In the broad sense, exposed walls include roofs, windows, and the generally recognized building walls. More buildings adopt light-pervious materials, such as glass, as the exposed walls. Consequently, the lines among the roofs, the exposed walls, and the windows appeared in traditional buildings become unclear gradually.

Nonetheless, this type of light-pervious building materials is not applied extensively to home buildings yet. In addition to price considerations, the provided functions still cannot satisfy various demands in different weather conditions and owing to changes of day and night. Thereby, it is urged that the functionality of light-pervious building materials should be improved and the adaptation and application of the overall building materials to the sun should be enhanced as well. In addition to the fundamental blocking and heat-isolating functions, it is highly potential for the development of future green buildings to be endowed with more active functions on the windows or the exposed walls that contact the sunlight directly.

The applications of current light-pervious building materials can be categorized into two types. The first is to dispose the light-pervious building material at the locations having most frequent sun illumination, for example, the roof. Thereby, when the sunlight illuminates the building material, it can penetrate the light-pervious building material and enter the building, thus increasing the ambient light inside. Secondly, likewise, the light-pervious building material is disposed at the locations having most frequent sun illumination and the building material is a light concentrating device. As the sunlight illuminates the light concentrating device, the light concentrating device has the effects of concentrating the sunlight and guiding the concentrated sunlight to a power generating apparatus for converting the sunlight to electricity, which can be thereby used by the equipment in the house. Unfortunately, no matter which type, instead of integrated application, the structure is designed to be disposed at the building independently. Hence, there is still room for improvements.

### SUMMARY

An objective of the present invention is to provide a multi-spiral optical device, which comprises a plurality of spiral channels. The multi-spiral optical device forms a light concentrating device and is applicable to solar power generating apparatuses or light driving apparatuses.

Another objective of the present invention is to provide a multi-spiral optical device, which fills or draws out a fluid inside the plurality of spiral channels for switching the optical states of the multi-spiral optical device. Namely, the multi-spiral optical device has multiple optical states and can be switched according to user's requirements.

The present invention discloses a multi-spiral optical device, which comprises a base and a plurality of spiral channels. The multi-spiral optical device is formed on a surface of the base. Each spiral channel includes a first port and a second port. The plurality of first ports are located at the center of the base whereas the plurality of second ports are located at the periphery of the base.

The present invention discloses another multi-spiral optical device, which comprises a base and a plurality of spiral channels. The multi-spiral optical device is formed on a surface of the base. Each spiral channel includes a first port and a second port. The plurality of first ports are located at the center of the base whereas the plurality of second ports are located at the periphery of the base. In addition, a fluid can be filled to or drawn out from one of more of the plurality of spiral channels selectively for switching the optical states of the multi-spiral optical device.

### BRIEF DESCRIPTION OF THE DRAWINGS

FIG. 1 shows a schematic diagram of the multi-spiral optical device according to the first embodiment of the present invention;

FIG. 2 shows a cross-sectional view of the multi-spiral optical device according to the first embodiment of the present invention;

FIG. 3 shows a usage status diagram of the multi-spiral optical device according to the second embodiment of the present invention;

FIG. 4 shows a cross-sectional view of the multi-spiral optical device according to the third embodiment of the present invention;

FIG. 5 shows a cross-sectional view of the multi-spiral optical device according to the fourth embodiment of the present invention;

FIG. 6 shows a cross-sectional view of the multi-spiral optical device according to the fifth embodiment of the present invention;

FIG. 7 shows a schematic diagram of the interface part according to the sixth embodiment of the present invention;

FIG. 8 shows a schematic diagram of the interface part according to the seventh embodiment of the present invention;

FIG. 9 shows a schematic diagram of the interface part according to the eighth embodiment of the present invention; and

FIG. 10 shows a schematic diagram of the multi-spiral optical device according to the ninth embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

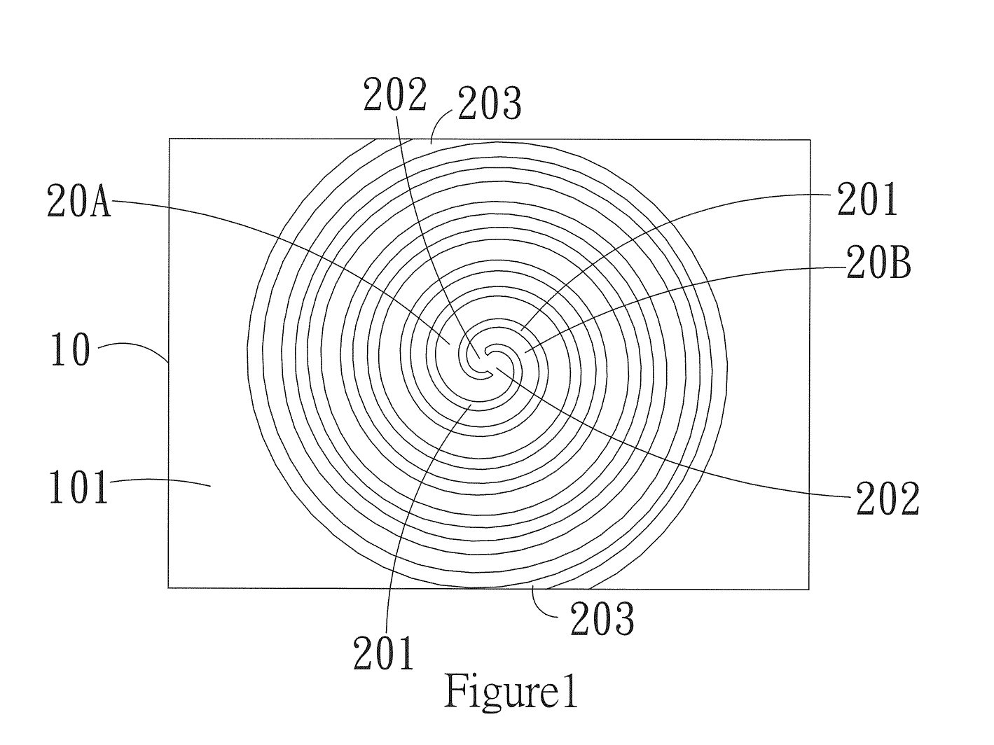

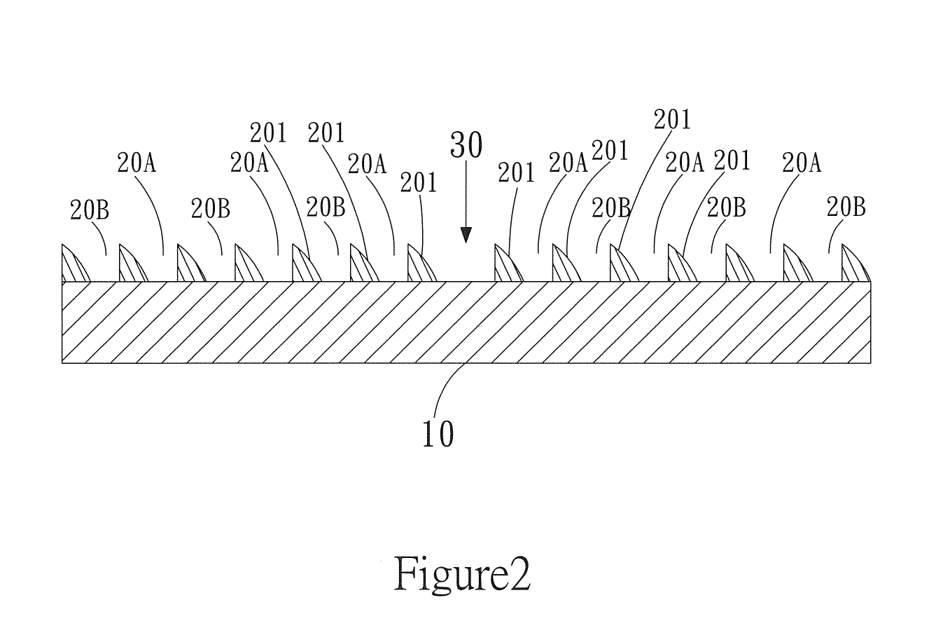

Please refer to FIG. 1 and FIG. 2, which show a schematic diagram and a cross-sectional view of the multi-spiral optical device according to the first embodiment of the present invention. As shown in the figures, the embodiment provides a multi-spiral optical device, which comprises a base 10 and a plurality of spiral channels 20A, 20B. The plurality of spiral channels 20A, 20B are formed on a surface 101 of the base 10 and include a plurality of spiral sidewalls 201. The plurality of spiral sidewalls 201 are formed on the base 10. According to the present embodiment, the plurality of spiral sidewalls 201 are spaced at intervals on the base 10. The intervals between the plurality of spiral sidewalls 201 are identical. According to the present embodiment, two spiral sidewalls 201 form two spiral channels 20A, 20B. Thereby, the plurality of spiral channels 20A, 20B are spaced at identical intervals on the surface 101 of the base 10. Each of the spiral channel 20A, 20B includes a first port 202 and a second port 203. The plurality of first ports 202 are located at the center of the base 10; the plurality of second ports 203 are located at the periphery of the base 10.

The material of the base 10 according to the present embodiment is acrylic, glass, or other light-pervious materials. The plurality of spiral channels 20A, 20B and the base 10 according to the present embodiment are formed integrally. Thereby, the material of the plurality of spiral channels 20A, 20B is the same as that of the base 10. Thanks to the plurality of spiral channels 20A, 20B, the multi-spiral optical device according to the present embodiment forms a light concentrating device. The multi-spiral optical device according to the present embodiment can be applied to a solar power generating apparatus or a light driving apparatus. For example, when the multi-spiral optical device is applied to a solar power generating apparatus, it can concentrate the external sunlight to the solar power generating apparatus. The solar power generating apparatus converts the light energy to electric energy and supplies the electric energy to other electric apparatuses.

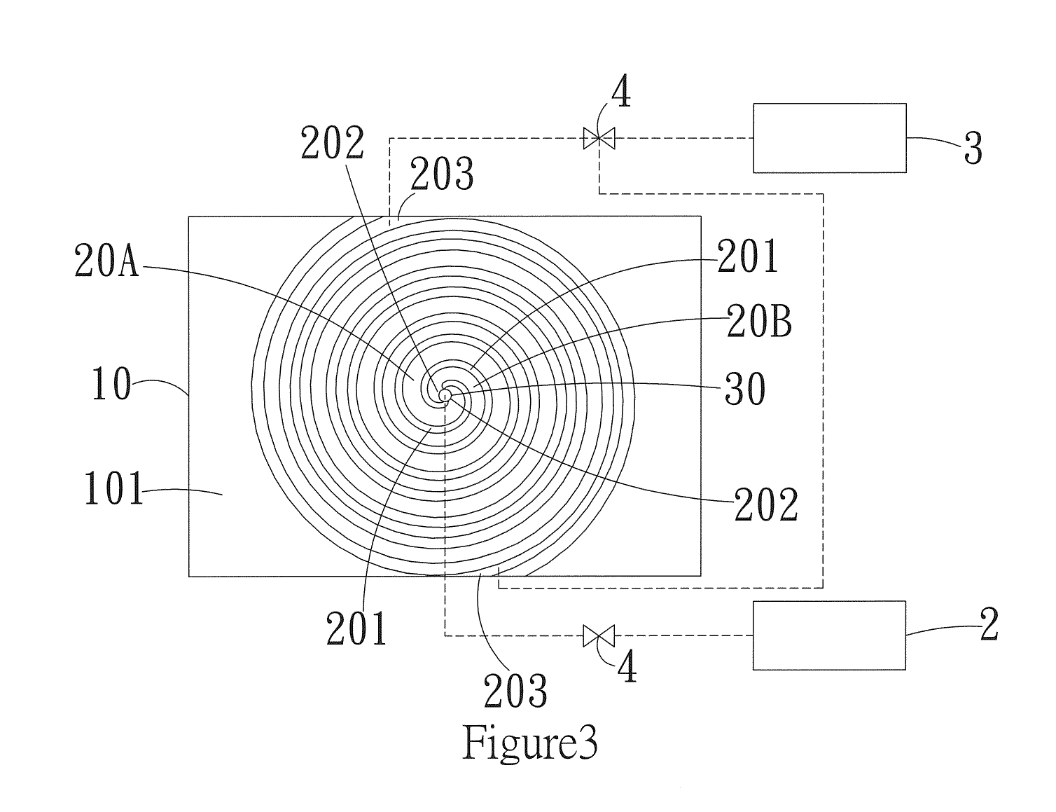

Please refer to FIG. 3, which shows a usage status diagram of the multi-spiral optical device according to the second embodiment of the present invention. As shown in the figure, the present embodiment illustrates that the optical states of the multi-spiral optical device can be switched by flowing a fluid into or out of the plurality of spiral channels 20A, 20B, and thus enabling the multi-spiral optical device according to the present embodiment to be an optical switch. When a fluid is filled to or drawn out from the plurality of first ports 202 or second ports 203, the optical state of the plurality of spiral channels 20A, 20B can be switched among a fully fluid-filled state, a non-fluid state, and a partially fluid-filled state. The optical states includes a light-pervious, a light-concentrating, a partially-light-pervious, a partially-light-concentrating, and a sheltering state.

The multi-spiral optical device according to the present embodiment further comprises an interface part 30 disposed on the base 10 and communicating with the plurality of first ports 202 and thus enabling the plurality of spiral channels 20A, 20B to communicate with one another. Accordingly, the fluid can be filled selectively via the interface part 30. The fluid enters the spiral channels 20A, 20B from the plurality of first ports 202. In other words, the fluid can flow concurrently in the plurality of spiral channels 20A, 20B. It is not necessary to inject the fluid into the first port 202 of each of the spiral channels 20A, 20B.

In the following, the method for using the multi-spiral optical device according to the present embodiment is described. According to the present embodiment, the interface part 30 is set to be a fluid inlet; the plurality of second ports 203 of the plurality of spiral channels 20A, 20B are set as fluid outlets. The interface part 30 can be connected to a fluid supply device 2. The plurality of second ports 203 can be connected to a fluid recycle device 3. The fluid supply device 2 supplies continuously a fluid to the interface part 30. The fluid flows from the interface part 30 into the plurality of first ports 202 of the plurality of spiral channels 20A, 20B, and then into the plurality of spiral channels 20A, 20B. The fluid filled fully the plurality of spiral channels 20A, 20B. As the refractivity of the fluid is close to that of the base 10, the multi-spiral optical device allows exterior light to pass through. When the fluid is an opaque fluid, the multi-spiral optical device can block exterior light from passing through. According to the refractivity and transmissivity of the fluid, the optical state of the multi-spiral optical device can be switched to be light pervious or sheltering.

As the fluid supply device 2 stops supplying the fluid to the interface part 30, the fluid recycle device 3 starts to recycle the fluid in the plurality of spiral channels 20A, 20B. After the fluid in the plurality of spiral channels 20A, 20B are recycled completely to the fluid recycle device 3, there will be no fluid inside the plurality of spiral channels 20A, 20B. Then, the exterior light will pass through the multi-spiral optical device and diffracted to demonstrate the light concentrating effect. Accordingly, the optical state of the multi-spiral optical device can be switched between the light-pervious and the light-concentrating states according to whether the fluid is filled in the plurality of spiral channels 20A, 20B.

According to the above description, by controlling the fluid to enter the plurality of spiral channels 20A, 20B, the multi-spiral optical device can exhibit multiple optical states. It means that users can control the fluid to flow into or out of the plurality of spiral channels 20A, 20B according to their needs for switching the optical state of the multi-spiral optical device.

Furthermore, according to the present embodiment, a fluid control device 4 is disposed between the interface part 30 and the fluid supply device 2 and between the plurality of second ports 203 and the fluid recycle device 3. The fluid control device 4 can be a control valve or a pump for controlling the quantity or the flowing rate by which the fluid flows into the plurality of spiral channels 20A, 20B. Hence, the fluid can be controlled to fill the plurality of spiral channels 20A, 20B fully or partially, or to draw the fluid out of the plurality of spiral channels 20A, 20B completely or partially.

The multi-spiral optical device according to the present embodiment comprises two spiral channels 20A, 20B. Nonetheless, it is only an embodiment of the present invention. The multi-spiral optical device according to the present invention may comprise two or more spiral channels 20A, 20B. The details will not be described further. The interface part 30 according to the above embodiment is the fluid inlet; the plurality of second ports 203 are fluid outlets. Alternatively, the interface part 30 can be the fluid outlet whereas the plurality of second ports 203 are the fluid inlets. The interface part 30 is connected with the fluid recycle device 3; the plurality of second ports 203 are connected with the fluid supply device 2. Thereby, the fluid can enter from the plurality of second ports 203 and flow out from the interface part 30. Alternatively, the interface part 30 and the plurality of second ports 203 can act both as the fluid inlets and as the fluid outlets. The fluid supply device 2 and the fluid recycle device 3 are connected with the plurality of second ports 203 or the interface part 30 concurrently, and thus enabling the fluid to enter or flow out via the interface part 30 or the plurality of second ports 203 concurrently.

The multi-spiral optical device according to the present embodiment can be applied to buildings and disposed at locations illuminated by the sunlight, for example, roof, balconies, or windows. The multi-spiral optical device according to the present embodiment can switch its optical state by flowing the fluid into plurality of spiral channels 20A, 20B. When the plurality of spiral channels 20A, 20B are filled fully with the fluid, the sunlight exterior to the buildings can pass through the multi-spiral optical device according to the present embodiment into the interior of the buildings, increasing the brightness inside the buildings. Thereby, the use of indoor lighting equipment can be reduced and achieving the efficacy of saving energy.

When the plurality of spiral channels 20A, 20B are filled with an opaque fluid, the multi-spiral optical device according to the present embodiment can block the exterior sunlight from entering the buildings for lowering the temperature inside the buildings and thus reducing the use of air-conditioning equipment inside the buildings. Thereby, the power consumption for regulating indoor temperature can be saved and hence achieving the efficacy of saving energy. When no fluid is filled into the plurality of spiral channels 20A, 20B, the multi-spiral optical device according to the present embodiment can concentrate the sunlight exterior to the buildings and guide the sunlight to the solar power generating apparatuses. The solar power generating apparatuses can convert the photo energy to electrical energy, which is then stored and supplied to the electrical equipment inside the buildings. Accordingly, the natural energy can be used for power generation and achieving the efficacy of saving energy. Besides, the solar power generating apparatuses can be replaced by other light driving apparatuses. When the plurality of spiral channels 20A, 20B are filled partially with the fluid, the sunlight exterior to the buildings can enter the buildings and enhance the indoor lighting. In addition, the sunlight can be concentrated to solar power generating or light driving apparatuses as well for making use natural energy in power generation. Accordingly, when the multi-spiral optical device according to the present embodiment is applied to buildings, the indoor lighting can be improved by using natural energy; the indoor temperature can be reduced and thereby the reducing the use of air conditioners; or the photo energy can be converted to electrical energy and supplied to indoor electrical equipment. All these facilitate saving energy effectively.

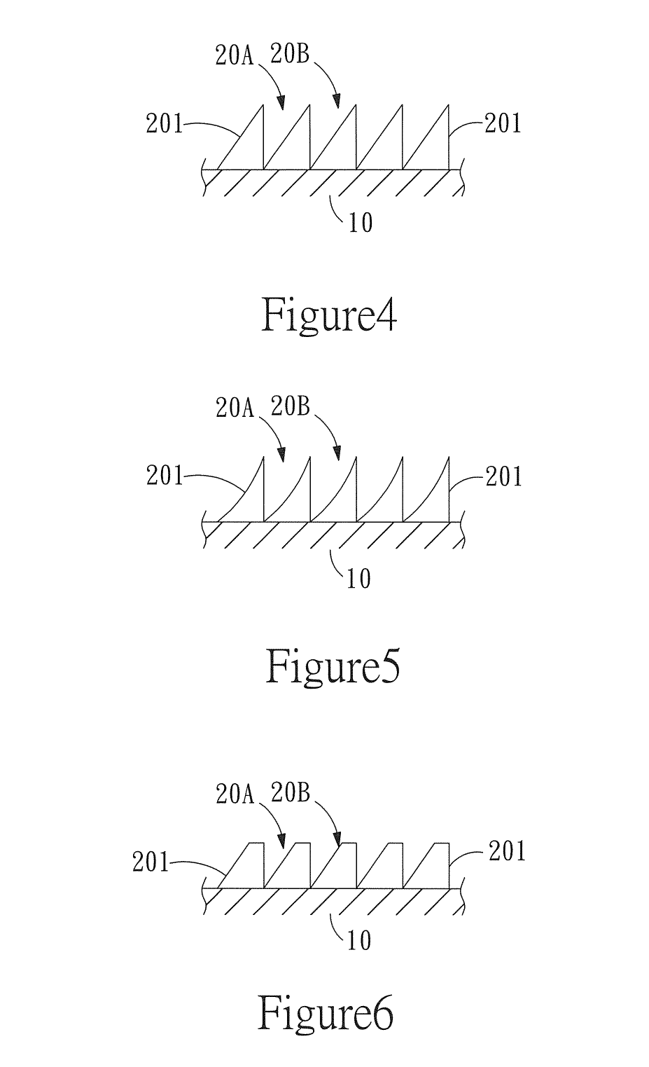

Please refer to FIGS. 4 to 6, which show cross-sectional views of the spiral channels according to the third to the fifth embodiments of the present invention. The plurality of spiral sidewalls 201 according to the third to the fifth embodiments are formed adjacently on the base 10. As shown in the figures, the cross-sections of the plurality of spiral sidewalls 201 of the plurality of spiral channels 20A, 20B according to the first embodiment are fan-shaped, as shown in FIG. 2. The cross-sections of the plurality of spiral sidewalls 201 according to the third to the fifth embodiments can be triangular, as shown in FIGS. 4 and 5, trapezoidal, as shown in FIG. 6, or polygonal. Because the plurality of spiral sidewalls 201 form the plurality of spiral channels 20A, 20B, the cross-sections of the plurality of spiral channels 20A, 20B according to the first embodiment are trapezoidal, as shown in FIG. 2, while the cross-sections of the plurality of spiral channels 20A, 20B according to the third to the fifth embodiments are triangular, as shown in FIGS. 4 and 6, or fan-shaped, as shown in FIG. 5. The cross-sections of the plurality of spiral sidewalls 201 are determined by users' requirements. The details will not be described here.

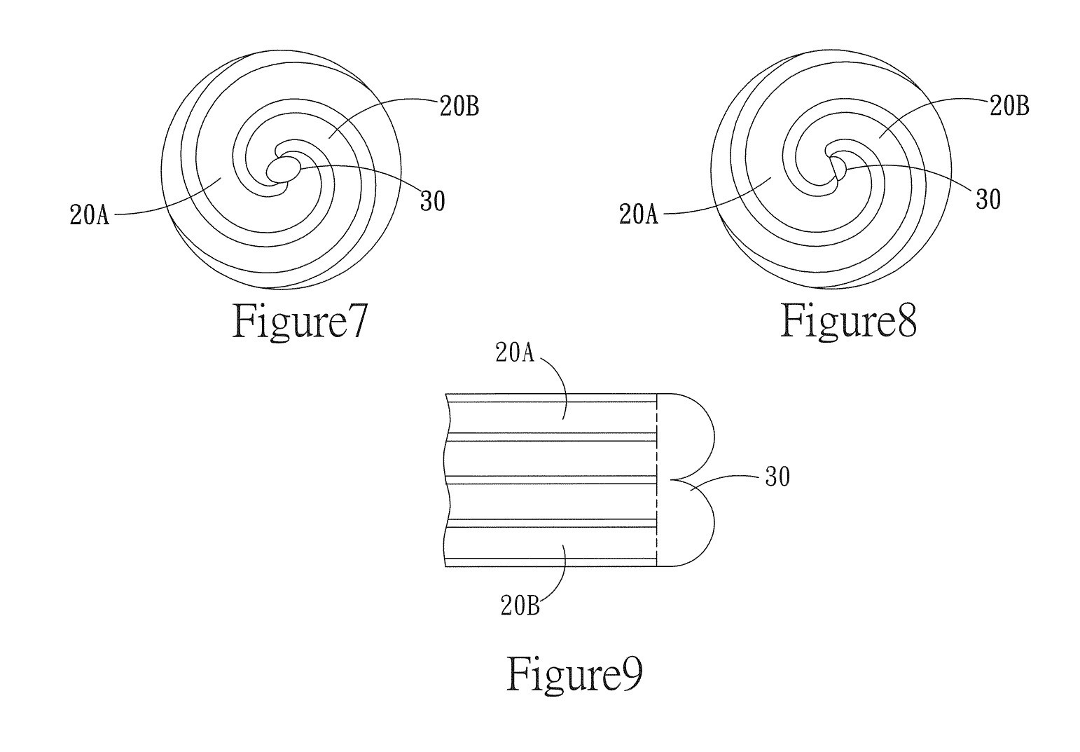

Please refer to FIGS. 7 to 9, which show schematic diagrams of the interface part according to the sixth to the eighth embodiments of the present invention. As shown in the figures, the shape of the interface part 30 according to the second embodiment is circular. Here, interface parts 30 having different shapes are provided. As shown in FIG. 7, the shape of the interface part 30 is elliptic. As shown in FIG. 8, the shape of the interface part 30 is semicircular. As shown in FIG. 9, the shape of the interface part 30 includes two continuous semicircles. The shape of the interface part 30 can triangular or other geometric shapes. The shape of the interface part 30 should coincide with the cross-section of the pipes connecting the fluid supply device 2, the fluid recycle device 3, and the interface part 30, as shown in FIG. 3. The shapes of the interface part 30 described above are just some embodiments of the present invention. The shapes of the interface part 30 according to the present invention are not limited to the above shapes.

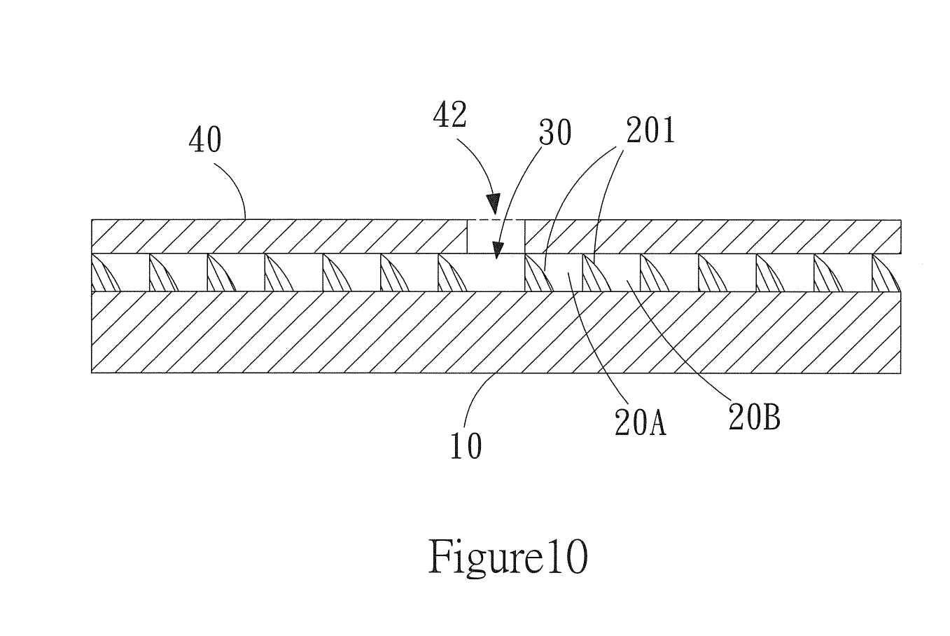

Please refer to FIG. 10, which shows a schematic diagram of the multi-spiral optical device according to the ninth embodiment of the present invention. As shown in the figure, the multi-spiral optical device according to the present embodiment further comprises a transparent lid 40 disposed on the base 10 and sealing the plurality of spiral channels 20A, 20B. If the fluid is filled into the plurality of spiral channels 20A, 20B, it will spill out of the plurality of spiral channels 20A, 20B as it flows therein. The transparent lid 40 includes a hole 42 corresponding to the interface part 30. Thereby, the interface part 30 can be connected with the fluid supply device 2 and the fluid recycle device 3, as shown in FIG. 3, via the hole 42.

To sum up, the present invention provides a multi-spiral optical device forming a plurality of spiral channel on a base and thus becoming a light concentrating device applicable to solar power generating or other light driving apparatuses. Depending on users' requirement, a fluid can be filled into or drawn out of the plurality of spiral channels selectively for switching the optical state of the multi-spiral optical device. Thereby, the multi-spiral optical device according to the present invention can be applied to buildings for achieving the efficacies of lighting, storing electricity, and saving energy.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A multi-spiral optical device, comprising:
a base; and
a plurality of spiral channels, formed on a surface of said base, each said spiral channel having a first port and a second port, said plurality of first port located at the center of said base, and said plurality of second ports located at the periphery of said base.

2. The multi-spiral optical device of claim 1, wherein said plurality of spiral channels includes a plurality of spiral sidewalls forming said plurality of spiral channels.

3. The multi-spiral optical device of claim 1, wherein the material of said base is acrylic or glass.

4. The multi-spiral optical device of claim 2, wherein the cross-section of said plurality of spiral sidewalls is fan-shaped, triangular, or trapezoidal and the cross-section of each said spiral channel is trapezoidal, triangular, or fan-shaped.

5. The multi-spiral optical device of claim 1, wherein said plurality of spiral channels are disposed at equal intervals.

6. A multi-spiral optical device, comprising:
a base; and
a plurality of spiral channels, formed on a surface of said base, each said spiral channel having a first port and a second port, said plurality of first port located at the center of said base, and said plurality of second ports located at the periphery of said base;
where a fluid can be filled to or drawn out of one or more of said plurality of spiral channels selectively for switching the optical state of said multi-spiral optical device.

7. The multi-spiral optical device of claim 6, further comprising an interface part, disposed on said base, and communicating with said plurality of first ports.

8. The multi-spiral optical device of claim 7, further comprising:
a fluid supply device, connected with said interface part, said plurality of first ports, or said plurality of second ports for supplying said fluid to said plurality of spiral channels; and
a fluid recycle device, connected with said interface part, said plurality of first ports, or said plurality of second ports for recycling said fluid from said plurality of spiral channels.

9. The multi-spiral optical device of claim 8, wherein the shape of said interface part coincides with the cross-section of a pipe of said fluid supply device or said fluid recycle device connected with said interface part and can be elliptic, semicircular, triangular, polygonal, continuous semicircles, or other geometric shapes.

10. The multi-spiral optical device of claim 7, and further comprising a transparent lid, disposed on said base, sealing said plurality of spiral channels, and having a hole corresponding to said interface part.
